(19) United States
(12) Patent Application Publication
(10) Pub. No.: US 2007/0240326 A1
(43) Pub. Date: Oct. 18, 2007

(54) Measure me baby examination table paper roll

(76) Inventors: Lana Cerbelli, Albertson, NY (US); Lorraine Karen Zimmerman, Levittown, NY (US)

Correspondence Address: LANA CERBELLI, 102 COVENTRY AVENUE, ALBERTSON, NY, 11507, US

(21) Appl. No.: 11/405,716

(22) Filed: Apr. 18, 2006

(51) Int. Cl. G01B 3/10

(52) U.S. Cl. 33/755; 33/512

(57) ABSTRACT

The invention offers improvement, safety and a convenient design apart from the existing examination table paper rolls. The new and improved paper rolls are made useful for most pediatrician examination tables. The simple convenience of an imprinted measuring tape left of center and, a precautionary measure to be hands free of an extra instrument in your hands when handling a baby or small child, while measuring the baby's length at a glance.

### BACKGROUND OF THE INVENTION

The invention is a Measure Me Baby Examination Table Paper Roll that is used to cover a standard 26.5″W×54″×72″L×33″H examination table in a Pediatrician doctors office.

The paper is used to cover a Pediatricians examination table when examining a baby or small child. The special feature is the tape measure imprinted directly onto the examination paper this is to measure the baby's growth at a glance. In my research, examination paper rolls do not include a imprinted measuring tape directly on the paper, and there is no perforation distinguishing the beginning and the ending of each sheet. In this invention it is important to distinguish each sheet to make better use of the measuring tape feature.

The Measure Me Baby Examination Table Paper Roll would be the solution to the well visit measurement task.

### BRIEF DESCRIPTION OF THE SEVERAL VIEWS OF THE DRAWINGS

FIG. 1 describes the inflated Full Scale View Of The Inch measurement reflecting the center meter that will also be applied to the Measure Me Baby Examination Table Paper Roll.

FIG. 2 describes the Front View of the Measure Me Baby Examination Paper Roll that is used on the standard 26.5″W×54″×72″L×33″H examination table in a Pediatrician doctors office. It features the 36″ imprinted measuring tape left of center directly on the examination paper. 24″ from the top begins the 36″ measuring tape. For the purpose of decreasing the scale of the measuring tape it does not show the center meter measurements for a more precise measurement. For the purpose of showing a full page, the front view on the drawing will show the perforation of the paper reflecting the entire one sheet showing off over 72″L. The Measure Me Baby Examination Table Paper Roll measures 24″W×72″L (or 144 cm) total.

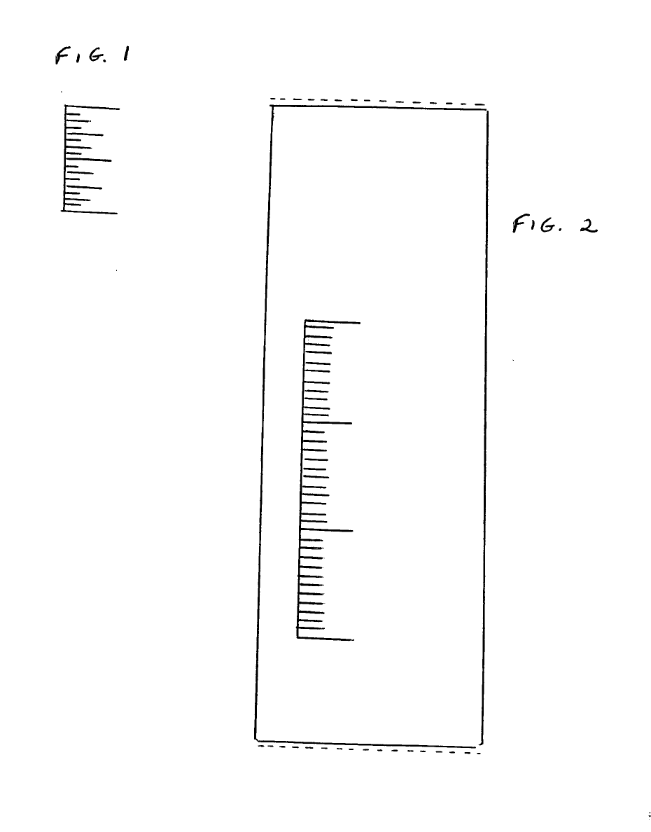

### BRIEF SUMMARY OF THE INVENTION

The invention is entitled Measure Me Baby Examination Table Paper Roll. It has the ability to measure a baby's length at a glance using a measuring tape in inches or center meters. The measuring tape is imprinted directly on the paper. From a pediatricians view it is convenient to not have to struggle with the baby to keep him/her still to measure their growth. The improved product offers the ability to measure the baby at a glance. The Measure Me Baby Examination Table Paper Roll is made for all standard examination tables, however it may be used for most examination tables. This invention can be used nationwide as well as international. The product is an innovative way to measure a baby's growth. It resolves the inconvenience of using a measuring tape to line up alongside the length of the child.

### DETAILED DESCRIPTION OF THE INVENTION

The Measure Me Baby Examination Table Paper Roll is made to cover the standard 26.5″W×54″×72″L×33″H Physician's examination table. The paper features an imprinted measuring tape to measure the a baby or small child's growth at a glance.

The Measure Me Baby Examination Table Paper Roll is perforated at 24″W×72″L reflecting the size of 1 sheet. The tape measure is imprinted in 36″ increments in accordance with where the baby or small child would be placed on the standard size physician's examination table. The tape measure is applied 24″ from what is considered the beginning of the examination table, there is then the imprinted 36″L measuring tape applied left of center of the examination table paper, and a remaining 12″ at the bottom thus equaling 72″L . Center meters are also shown on the measuring tape for those who prefers to measure in center meters for a more precise measurement.

The paper is described as a high quality pulp, it is a standard paper material used in all medical offices. In accordance with the medical practice standards it is suited for a one time use for each patient. The imprint is a simple black for easy reading as you lay the baby or small child down you will be able to read the measurement of the baby's length at a glance up to 36″.

The special imprinted measuring tape feature is what sets this Measure Me Baby Examination Table Paper Roll apart from all the rest, it is extremely convenient to be able to measure your patient without fussing with a measuring tape and have the ability to view the baby's length at a glance. The improvements offer measuring the baby's length or small child's length at a glance. The measurement feature has not been offered in the past and can be used for all national pediatricians or international pediatricians. The standard paper rolls being sold are primarily solid white or has prints.

The Measure Me Baby Examination Table Paper Roll is a product that is made useful by means of offering the convenience of not having to hold an extra item in your hand while trying to measure the length of a small patient. It also has the safety precaution of eliminating potentially harmful instruments in your hands while wrestling to keep a baby lying down long enough to measure him/her.

What we claim as our invention is a Measure Me Baby Examination Table Paper Roll:

1. The Measure Me Baby Examination Table Paper Roll offers:
1—A black 36″ L imprinted tape measuring in 36″L or 144 cm applied left of center of the Measure Me Baby Examination Table Paper Roll. This enables the pediatricians to measure a baby or small child's length at a glance.
2—A perforation reflecting the beginning and ending of each sheet used for each visit. to ensure proper usage of the imprinted tape measure.
These features offer improvement, safety and convenience apart from the existing examination table paper rolls on the market.
